(19) United States
(12) Patent Application Publication
(10) Pub. No.: US 2018/0354092 A1
(43) Pub. Date: Dec. 13, 2018

(54) COLD SANDING OF THERMOPLASTIC WORKPIECES

(71) Applicant: GM GLOBAL TECHNOLOGY OPERATIONS LLC, Detroit, MI (US)

(72) Inventor: Matthew E. Carroll, Grosse Pointe Woods, MI (US)

(73) Assignee: GM GLOBAL TECHNOLOGY OPERATIONS LLC, Detroit, MI (US)

(21) Appl. No.: 15/618,539

(22) Filed: Jun. 9, 2017

(51) Int. Cl. B24B 19/22; B24B 19/26; B24B 55/03; B29C 59/02

(52) U.S. Cl. CPC B24B 19/22; B24B 19/265; B29K 2023/12; B29C 59/02; B29C 2059/027; B24B 55/03

(57) ABSTRACT

A method includes: (a) actively cooling an outer surface of a workpiece until the outer surface reaches a predetermined surface temperature; and (b) sanding the outer surface of the workpiece when the outer surface of the workpiece has reached the predetermined surface temperature.

### INTRODUCTION

The present application relates to cold sanding of thermoplastic workpieces.

### SUMMARY

Sanding is usually performed to enhance the appearance of a workpiece. In vehicles, for example, an outermost surface of a vehicle component, such as a fascia or bumper, should be sanded to enhance the aesthetic appearance of the vehicle. It may be challenging to sand thermoplastic workpieces successfully for repair or finesse in production. Sanding thermoplastic workpieces heats and smears the thermoplastic in the workpiece. As a consequence, relatively large voids are formed in the thermoplastic, causing the thermoplastic to weaken.

Thermoplastic polyolefin (TPO) workpieces, for example, are particularly challenging to sand because of its multiphase state. That is, TPO workpieces are made of multiphase mixtures including a thermoplastic matrix, such as a polypropylene (PP) hard matrix, with rubber particles dispersed throughout the matrix, along with other additives like talc, processing aids, and pigments. The thermoplastic itself (e.g., the PP hard matrix) is prone to heat quickly, causing a thin layer of pure thermoplastic to form on the surface of the workpiece that prevents good adhesion to coatings (e.g., paint) after sanding. Therefore, it is desirable to develop a sanding method for thermoplastic materials that maintains the TPO sufficiently mixed to promote good adhesion to a coating after sanding. It is also desirable to develop a sanding method for thermoplastic materials that enhances the aesthetic appearance of the thermoplastic workpiece after the thermoplastic workpiece has been painted. The sanding is performed to remove flash, parting lines, dirt, nicks and other defects in the plastic surface that are often magnified once a bright, high gloss coating is applied to the plastic. Another issue with the warm thermoplastic surface is that the sanding particles furrow readily into the plastic creating scratches that are apparent after the subsequent painting operation. Cooling the surface prior to sanding helps harden it and allow the thermoplastic to “powder” better and furrow less.

To minimize weakening the thermoplastic workpiece during sanding, the present disclosure describes method for cold sanding thermoplastic workpieces. Thermoplastics typically increase in stiffness and strength as they get colder. Accordingly, sanding thermoplastics at a cold condition minimizes heat build-up and smearing during the sanding operation. Therefore, the presently disclosed cold sanding methods improve the sandability of thermoplastic workpieces.

In certain embodiments, the presently disclosed method includes: (a) actively cooling an outer surface of a workpiece until the outer surface reaches a predetermined surface temperature; and (b) sanding the outer surface of the workpiece after the outer surface of the workpiece has reached the predetermined surface temperature and while the outer surface of the workpiece is at the predetermined surface temperature. The workpiece is wholly or partly made of a thermoplastic polyolefin. For instance, the thermoplastic polyolefin may include a polypropylene matrix and rubber particles, and the rubber particles are dispersed throughout the polypropylene matrix. The predetermined surface temperature may be less than 68 degrees Fahrenheit. As a non-limiting example, the predetermined surface temperature may fall within a temperature range (i.e., between 33 degrees Fahrenheit and 67 degrees Fahrenheit). The method may further include maintaining the outer surface at the predetermined surface temperature while sanding the outer surface.

In some embodiments, actively cooling the outer surface of the workpiece may include dipping the workpiece in water. The water is contained in a reservoir, and the temperature of the water ranges between the 33 degrees Fahrenheit and 67 degrees Fahrenheit. The workpiece may be dipped in water for at least five minutes. Then, the workpiece is removed from the reservoir, and the outer surface of the workpiece is sanded after removing the workpiece from the reservoir. For example, the outer surface of the workpiece may be subjected to a wet sanding process. The wet sanding process includes discharging water onto the outer surface of the workpiece onto the outer surface after the outer surface has reached the predetermined surface temperature. The temperature of the discharged water may range between 33 degrees Fahrenheit and 52 degrees Fahrenheit.

In some embodiments, actively cooling the outer surface of the workpiece may include a cryogenic process. The cryogenic process includes emitting a cryogen toward the outer surface of the workpiece to cool the outer surface of the workpiece. The temperature of the cryogen may be equal to or less than −109 degrees Fahrenheit. The cryogen may include carbon dioxide, and the cryogenic process may include emitting the cryogenic toward the outer surface of the workpiece for 3 seconds. The cryogen may include nitrogen, and the cryogenic process may include emitting the cryogenic toward the outer surface of the workpiece for one second. The outer surface of the workpiece may be subjected to a dry sanding process. The dry sanding process is performed without discharging a liquid onto the outer surface of the workpiece. The cryogenic process may further include continuously emitting the cryogenic toward the outer surface of the workpiece at the same time as the dry sanding process is performed. The cryogenic process may include emitting the cryogenic through a nozzle. The dry sanding process may include moving a dry sander along the outer surface while the dry sander is in direct contact with the outer surface. The presently disclosed method may further include moving the nozzle at the same time as the dry sander is moved along the outer surface. As a result, the dry sander follows the nozzle to allow the dry sander to work on the portion of the outer surface that have been already cooled by the cryogen emitted from the nozzle.

In some embodiments, the method includes: (a) actively cooling an outer surface of a workpiece until the outer surface reaches a predetermined surface temperature; and (b) sanding the outer surface of the workpiece after the outer surface of the workpiece has reached the predetermined surface temperature. The predetermined surface temperature is less than 68 degrees Fahrenheit. The workpiece may be wholly or partly made of a thermoplastic polyolefin. The thermoplastic polyolefin may include a polypropylene matrix and rubber particles. The rubber particles are dispersed throughout the polypropylene matrix. The predetermined surface temperature may fall within a temperature ranging between 33 degrees Fahrenheit and 67 degrees Fahrenheit.

Actively cooling the outer surface of the workpiece may include dipping the workpiece in reservoir water. The reservoir water is contained in a reservoir, and a temperature of the reservoir water ranges between the 33 degrees Fahrenheit and 67 degrees Fahrenheit. Dipping the workpiece in water includes dipping the workpiece in water solely for five minutes. The method may further include completely removing the workpiece from the reservoir. Sanding the outer surface of the workpiece is performed after completely removing the workpiece from the reservoir. Sanding the outer surface of the workpiece includes a wet sanding process. The wet sanding process includes discharging water onto the outer surface of the workpiece to maintain the outer surface at the predetermined surface temperature. The temperature of the discharged water may range between the 33 degrees Fahrenheit and 67 degrees Fahrenheit. The wet sanding process is performed using a wet sander. The wet sander includes a support body, a rotatable sanding pad coupled to the support body, a first guide post protruding from the support body, a second guide post protruding from the support body, and a tubing coupled to the support body and configured to deliver the water to be discharged onto the outer surface of the workpiece. The tubing has a thermal insulation, and the thermal insulation has an R-value of 7 ft²·° F.·h/Btu to minimize heat transfer between the water flowing through the tubing and the atmosphere. The first guide post is wholly made of polytetrafluoroethylene. The second guide post is made of polytetrafluoroethylene. The first guide post is in direct contact with the outer surface of the workpiece during the wet sanding process. The second guide post is in direct contact with the outer surface of the workpiece during the wet sanding process. The workpiece is a front bumper of a vehicle. Dipping the workpiece into water may include dipping the workpiece such that an entirety of the outer surface is submerged in the reservoir water.

Cooling the outer surface of the workpiece may entail a cryogenic process. The cryogenic process may include emitting a cryogen toward the outer surface of the workpiece to cool the outer surface of the workpiece. The temperature of the cryogen may be −109 degrees Fahrenheit before being emitted toward the outer surface of the workpiece. The cryogen may solely include carbon dioxide. Sanding the outer surface of the workpiece may solely include a dry sanding process. The dry sanding process is performed without discharging a liquid onto the outer surface of the workpiece so that the sanding occurs solely when the outer surface of the workpiece is completely dry. The cryogenic process may further include continuously emitting the cryogen toward the outer surface of the workpiece at the same time as the dry sanding process is performed. The method may include stopping emitting the cryogen toward the outer surface of the workpiece solely when the dry sanding process is completed. The cryogenic process may include emitting the cryogenic through a nozzle. The dry sanding process may include moving a dry sander along the outer surface while the dry sander is in direct contact with the outer surface. The method may further include moving the nozzle at the same time as the dry sander is moved along the outer surface such that the dry sander follows the nozzle to allow the dry sander to work on a portion of the outer surface that has already been cooled by the cryogen emitted from the nozzle. Moving the dry sander and moving the nozzle occur simultaneously. Moving the dry sander includes moving the dry sander in a direction orthogonal to the outer surface. Moving the nozzle includes moving the nozzle at the direction orthogonal to the outer surface. Moving the dry sander includes moving the dry sander at a first speed. Moving the nozzle includes moving the nozzle at a second speed. The first speed is equal to the second speed. The method further includes maintaining a space between the dry sander and the nozzle while moving the dry sander and the nozzle. The space has a constant distance measured from the dry sander to the nozzle along the direction orthogonal to the outer surface. The method further includes maintaining the constant distance of the space while moving the dry sander and the nozzle to avoid emitting cryogen toward the dry sander. The carbon dioxide is in liquid state before the being emitted from the nozzle. The carbon dioxide vaporizes when being emitted from the nozzle. The nozzle has a first nozzle end and a second nozzle end opposite the first nozzle end. The carbon dioxide is emitted from the second nozzle end. The second nozzle end is spaced apart from the outer surface of the workpiece to allow the carbon dioxide to vaporize before contacting the outer surface of the workpiece. The thermoplastic polyolefin further includes additives. The additives may include talc, processing aids, and pigments. The method may further include painting the outer surface of the workpiece after sanding the outer surface of the workpiece. The workpiece may be a front bumper of a vehicle.

In certain embodiments, the method includes: (a) cooling an outer surface of a workpiece until the outer surface reaches a predetermined surface temperature; and (b) sanding the outer surface of the workpiece after the outer surface of the workpiece has reached the predetermined surface temperature. The predetermined surface temperature is less than 68 degrees Fahrenheit. The workpiece includes a thermoplastic polyolefin. The thermoplastic polyolefin includes a polypropylene matrix and rubber particles. The rubber particles are dispersed throughout the polypropylene matrix. The predetermined surface temperature falls within a temperature ranging between 33 degrees Fahrenheit and 67 degrees Fahrenheit.

Cooling the outer surface of the workpiece includes dipping the workpiece in reservoir water. The reservoir water is contained in a reservoir. The temperature of the reservoir water ranges between the 33 degrees Fahrenheit and 67 degrees Fahrenheit. Dipping the workpiece in water includes dipping the workpiece in water solely for five minutes. The method may further include completely removing the workpiece from the reservoir. Sanding the outer surface of the workpiece is performed after completely removing the workpiece from the reservoir. Sanding the outer surface of the workpiece may entail a wet sanding process. The wet sanding process includes discharging water onto the outer surface of the workpiece to maintain the outer surface at the predetermined surface temperature. The temperature of the discharged water may range between the 33 degrees Fahrenheit and 67 degrees Fahrenheit. The wet sanding process is performed using a wet sander. The wet sander may include a support body, a rotatable sanding pad coupled to the support body, a first guide post protruding from the support body, a second guide post protruding from the support body, and a tubing coupled to the support body and configured to deliver the water to be discharged onto the outer surface of the workpiece. The tubing has a thermal insulation, and the thermal insulation has an R-value of 7 ft²·° F.·h/Btu to minimize heat transfer between the water flowing through the tubing and the atmosphere. The first guide post is wholly made of polytetrafluoroethylene. The second guide post is made of polytetrafluoroethylene. The first guide post is in direct contact with the outer surface of the workpiece during the wet sanding process. The second guide post is in direct contact with the outer surface of the workpiece during the wet sanding process. The workpiece may be a front bumper of a vehicle. Dipping the workpiece into water may include dipping the workpiece such that an entirety of the outer surface is submerged in the reservoir water.

Cooling the outer surface of the workpiece includes a cryogenic process. The cryogenic process may entail emitting a cryogen toward the outer surface of the workpiece to cool the outer surface of the workpiece. The temperature of the cryogen may be −109 degrees Fahrenheit before being emitted toward the outer surface of the workpiece. The cryogen may solely include carbon dioxide. Sanding the outer surface of the workpiece may solely include a dry sanding process. The dry sanding process is performed without discharging a liquid onto the outer surface of the workpiece so that the sanding occurs solely when the outer surface of the workpiece is completely dry. The cryogenic process further includes continuously emitting the cryogen toward the outer surface of the workpiece at the same time as the dry sanding process is performed. The method may include stopping emitting the cryogen toward the outer surface of the workpiece solely when the dry sanding process is completed. The cryogenic process may include emitting the cryogenic through a nozzle. The dry sanding process may include moving a dry sander along the outer surface while the dry sander is in direct contact with the outer surface. The method may further include moving the nozzle at the same time as the dry sander is moved along the outer surface such that the dry sander follows the nozzle to allow the dry sander to work on a portion of the outer surface that has already been cooled by the cryogen emitted from the nozzle. Moving the dry sander and moving the nozzle may occur simultaneously. Moving the dry sander includes moving the dry sander in a direction orthogonal to the outer surface. Moving the nozzle includes moving the nozzle at the direction orthogonal to the outer surface. Moving the dry sander may include moving the dry sander at a first speed. Moving the nozzle may include moving the nozzle at a second speed. The first speed may be equal to the second speed. The method may further include maintaining a space between the dry sander and the nozzle while moving the dry sander and the nozzle. The space has a constant distance measured from the dry sander to the nozzle along the direction orthogonal to the outer surface. The method may further include maintaining the constant distance of the space while moving the dry sander and the nozzle to avoid emitting cryogen toward the dry sander. The carbon dioxide may be in liquid state before the being emitted from the nozzle. The carbon dioxide may vaporize when being emitted from the nozzle. The nozzle has a first nozzle end and a second nozzle end opposite the first nozzle end. The carbon dioxide may be emitted from the second nozzle end. The second nozzle end is spaced apart from the outer surface of the workpiece to allow the carbon dioxide to vaporize before contacting the outer surface of the workpiece. The thermoplastic polyolefin may further include additives. The additives include talc and pigments. The method may further include painting the outer surface of the workpiece after sanding the outer surface of the workpiece. The workpiece may be a front bumper of a vehicle.

The above features and advantages and other features and advantages of the present disclosure are readily apparent from the following detailed description of the best modes for carrying out the disclosure when taken in connection with the accompanying drawings.

### BRIEF DESCRIPTION OF THE DRAWINGS

FIG. 1 is a flowchart of a method for cold sanding thermoplastic workpieces.

FIG. 2 is a schematic illustration of a workpiece being placed into a water reservoir.

FIG. 3 is a schematic illustration of a workpiece being subjected to a wet sanding process.

FIG. 4 is a schematic illustration of a workpiece being cooled using a cryogenic process.

FIG. 5 is a schematic illustration of a workpiece being subjected to a dry sanding process.

### DETAILED DESCRIPTION

Sanding is usually performed to enhance the appearance of a workpiece. In vehicles, for example, an outermost surface of a vehicle component, such as a fascia or bumper, should be sanded to enhance the aesthetic appearance of the vehicle. It may be challenging to sand thermoplastic workpieces successfully for repair or finesse in production. Sanding thermoplastic workpieces heats and smears the thermoplastic in the workpiece. As a consequence, relatively large voids are formed in the thermoplastic, causing the thermoplastic to weaken.

Thermoplastic polyolefin (TPO) workpieces, for example, are particularly challenging to sand because of its multiphase state. That is, TPO workpieces are made of multiphase mixtures including a thermoplastic matrix, such as polypropylene (PP) hard matrix, with rubber particles dispersed throughout the matrix, along with other additives like talc, processing aids, and pigments. The thermoplastic itself (e.g., the PP hard matrix) is prone to heat quickly, causing a thin layer of pure thermoplastic to form on the surface of the workpiece that prevents good adhesion to coatings (e.g., paint) after sanding. Therefore, it is desirable to develop a sanding method for thermoplastic materials that maintains the TPO sufficiently mixed to promote good adhesion to a coating after sanding.

To minimize weakening the thermoplastic workpiece during sanding, the present disclosure describes method for cold sanding thermoplastic workpieces. Thermoplastics typically increase in stiffness and strength as they get colder. Accordingly, sanding thermoplastics at a cold condition minimizes heat build-up and smearing during the sanding operation. Heat also shortens the life of the sanding paper. Therefore, the presently disclosed cold sanding methods improve the sandability of thermoplastic workpieces.

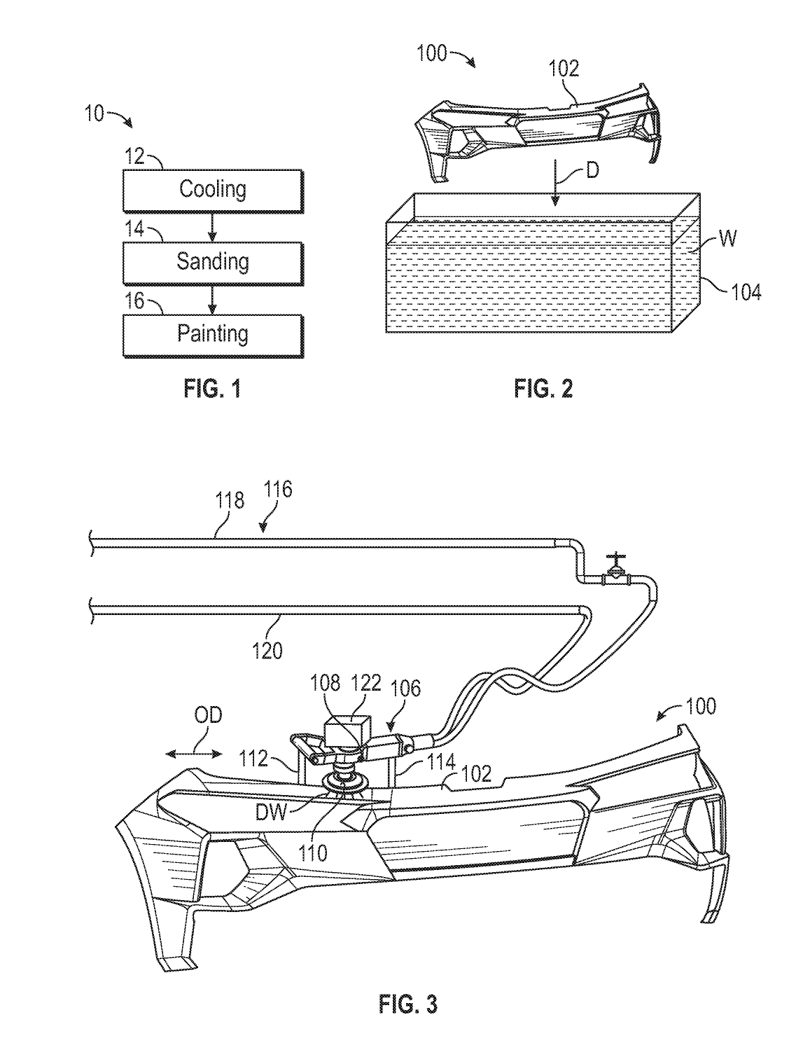

With reference to FIG. 1, the presently disclosed method 10 for cold sanding of thermoplastic workpieces. At block 12, an outer surface 102 of a workpiece 100 (FIG. 3) is actively cooled until the outer surface reaches a predetermined surface temperature to improve sandability of the workpiece 100. To this end, the predetermined surface temperature should be below ambient temperature (i.e., less than less than 68 degrees Fahrenheit). As a non-limiting example, the predetermined surface temperature may fall within a range of 33 degrees Fahrenheit and 67 degrees Fahrenheit to enhance the sandability of the workpiece 100.

After cooling the outer surface 102 of the workpiece 100, the method 10 proceeds to block 14. At block 14, the outer surface 102 of the workpiece 100 is sanded using for example a sander. Specifically, after the outer surface 102 of the workpiece 100 has reached the predetermined surface temperature, the outer surface 102 is sanded. The outer surface 102 should be sanded while the outer surface 102 is at the predetermined surface temperature in order to minimize weakening of the outer surface 102, thereby improving sandability. After sanding, the method 10 proceeds to block 16. At block 16, the outer surface 102 may be painted or coated to enhance the aesthetic appearance of the workpiece 100.

With reference to FIG. 2, the outer surface 102 of the workpiece 100 may cooled using different processes. Regardless of the cooling processes employed, the presently disclosed processes are suitable for the workpieces 100 that are wholly or partially made of a thermoplastic material. As non-limiting example, the workpiece 100 may be wholly or partly made of a thermoplastic polyolefin (TPO). TPO workpieces 100 are made of multiphase mixtures including a thermoplastic matrix, such as polypropylene (PP) hard matrix, with rubber particles dispersed throughout the matrix, along with other additives like talc, processing aids, and pigments. For instance, the TPO workpiece 100 may include a polypropylene (PP) hard matrix and rubber particles, and the rubber particles are dispersed throughout the PP hard matrix. As shown in FIG. 2, the outer surface 102 of the workpiece 100 may entail dipping the workpiece 100 in water W contained in a reservoir 104, such as a tank. To do so, the workpiece 100 is moved in the direction D toward the water W contained in the reservoir 104. To properly cool the outer surface 102, at least the outer surface 102 should be entirely submerged in the water W, and the temperature of the water W should range between the 33 degrees Fahrenheit and 67 degrees Fahrenheit to stiffen and strengthen the thermoplastic material before sanding. The temperature of the water W should be at or above its freezing point (32 degrees Fahrenheit) to allow the workpiece 100 to be submerged into the water W. It is contemplated that the workpiece 100 could be entirely submerged into the water W. The workpiece 100 should be dipped in the water W contained in the reservoir 104 for at least five minutes in order to allow the outer surface 102 to reach the predetermined surface temperature. As a non-limiting example, the workpiece 100 may be dipped in the water W for one to five minutes before sanding. It is envisioned that the workpiece 100 can be dipped in the water W for solely five minutes for efficiency purposes, and that time should be sufficient to reach the predetermined surface temperature. After appropriately cooling the workpiece 100, the workpiece 100 can be removed from the reservoir 104, and the outer surface 102 of the workpiece 100 is performed after completely removing the workpiece 100 from the reservoir 104 to allow proper sanding of the outer surface 102.

With reference to FIG. 3, after dipping the workpiece 100 in water W, the outer surface 102 of the workpiece 100 can be sanded using a wet sanding process, because the temperature of the outer surface 102 is above the freezing point of water W (i.e., above 32 degrees Fahrenheit). In other words, wet sanding can be performed on the outer surface 102 after the dipping process described above, because the temperature of the outer surface 102 is above the freezing point of water. The wet sanding process includes discharging water (i.e., the discharged water DW) onto the outer surface 102 of the workpiece 102 to maintain the outer surface 102 at (or at least near) the predetermined surface temperature. The temperature of the discharged water DW may range between the 33 degrees Fahrenheit and 67 degrees Fahrenheit to maintain the outer surface 102 at (or at least near) the predetermined surface temperature. The wet sanding process is performed using a wet sander 106. The wet sander 106 includes a support body 108 and a rotatable sanding pad 110 coupled to the support body 108. The wet sander 106 further includes a first guide post 112 protruding from the support body 108 and a second guide post 114 protruding from the support body 108. The first guide post 112 and the second guide post 114 help guide the rotatable sanding pad 110 along the outer surface 102 of the workpiece 100. The wet sander 106 further includes tubing 116 coupled to the support body 108 and configured to deliver the water to be discharged onto the outer surface 102 of the workpiece 100. The tubing 116 has a thermal insulation 118, and the thermal insulation has an R-value of 7 ft²·° F.·h/Btu to minimize heat transfer between the water flowing through the tubing 116 and the atmosphere. The first guide post 112 and the second guide post 114 are wholly or partly made of made of polytetrafluoroethylene to facilitate sliding along the outer surface 102 of the workpiece 100. Accordingly, the first guide post 112 and the second guide post 114 can be in direct contact with the outer surface 102 of the workpiece 100 during the wet sanding process to help guide the rotatable sanding pad 110 along the outer surface 102 of the workpiece 100. The wet sander 106 also includes an electrical or pneumatic pressure line 120 to deliver power to the rotatable sanding pad 110, thereby allowing the rotatable sanding pad 110 to rotate. As shown in FIG. 3, the workpiece 100 may be a front bumper or a fascia of a vehicle. During the wet sanding process, the wet sander 106 is moved along the outer surface 102 of the workpiece 100 along a direction orthogonal to the outer surface 102 as indicated by double arrows OD. During the wet sanding process, the rotatable sanding pad 110 should be in direct contact with the outer surface 102 of the workpiece 100 to allow the wet sander 106 to sand the outer surface 102. To facilitate this direct contact, the wet sander 106 includes a mass 122 having a constant weight supported by the support body 108. The mass 122 helps maintain the rotatable sanding pad 110 in direct contact with the outer surface 102 of the workpiece 100. Machine sanding is faster and better than manual sanding, but too many RPMs of the sander generates heat between the workpiece 100 and the sandpaper, causing the sandpaper to erode quickly. Because electric sanders have a heavy armature, these sanders have much more torque at low speeds than pneumatic sanders. The low speeds adequately rough up the thermoplastic surface without overheating, melting and smearing the surface the way air sanders do. By using wet sanding (as opposed to dry sanding) the sandpaper last longer as the water washes the dwarf completely out of the way. The water also acts as a lubricant, cools the outer surface 102, extends sandpaper life by three to five times (as compared to dry sanding) and allows for a bigger margin of error. This error refers to when the thermoplastic resin reforms into a ball from the sander's heart and gets caught under the pad, or the smearing melted plastic. It is envisioned that dry sanding with different grits may be done first; then, the outer surface 102 is wet sanded. Then, the outer surface 102 is primed. Afterward, the outer surface 102 and the primer are wet sanded. Finally, the outer surface 102 is cooled with cool water. During the wet sanding process, the operator should use as much water as possible to prevent the plastic from burning. Although FIG. 3 shows the that the wet sander 106 is a mechanical sander, manual sanding can be employed using similar pads and paper as the ones that are used by the mechanical sanders. For wet sanding manually, the cold water can be sprayed onto the workpiece 100 just prior to sanding. Soap may be added to the water to help lubricate the sanding operation as well.

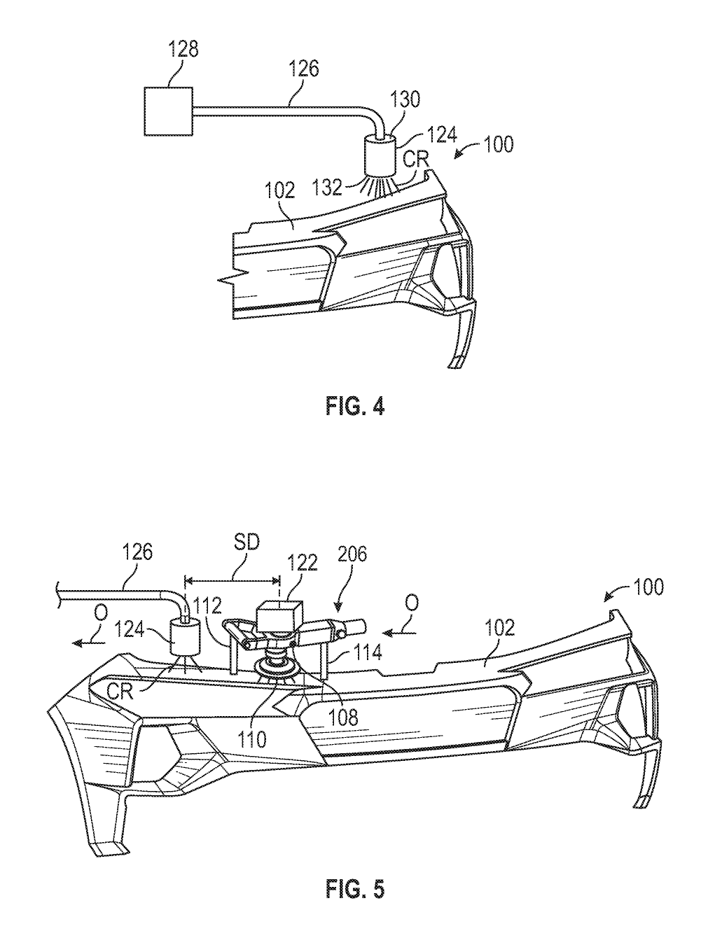

With reference to FIG. 4, the outer surface 102 of the workpiece 100 may be cooled using a cryogenic process. The cryogenic process includes emitting a cryogen CR toward the outer surface 102 of the workpiece 100 to cool the outer surface 102 of the workpiece 100. The temperature of the cryogen may be −109 degrees Fahrenheit before being emitted toward the outer surface 102 of the workpiece 100 to allow quick cooling of the outer surface 102. It is envisioned that the cryogen CR may solely include carbon dioxide. The cryogen CR may be emitted through a nozzle 124. Cryogen lines 126 are in fluid communication with the nozzle 124 and a cryogen source 128 to allow delivery of the cryogen CR to the nozzle 124. The cryogen (e.g., carbon dioxide or nitrogen) is in liquid state before the being emitted from the nozzle 124. Then, the cryogen (e.g., carbon dioxide or nitrogen) vaporizes when being emitted from the nozzle 124. The nozzle 124 has a first nozzle end 130 and a second nozzle end 132 opposite the first nozzle end 130. The cryogen CR (e.g., carbon dioxide or nitrogen) is emitted from the second nozzle end 132, and the second nozzle end 132 is spaced apart from the outer surface 102 of the workpiece 100 to allow the cryogen CR (e.g., carbon dioxide or nitrogen) to vaporize before contacting the outer surface 102 of the workpiece 100. If carbon dioxide is used as a cryogen CR, the cryogen CR is emitted toward the outer surface 102 of the workpiece 100 solely for 3 seconds to maximize efficiency and properly cool the outer surface 102. If nitrogen is used as a cryogen CR, the cryogen CR is emitted toward the outer surface 102 of the workpiece 100 solely for one second to maximize efficiency and properly cool the outer surface 102. The cryogenic process also helps to clean the outer surface 102 before sanding. Alternatively or additionally, wax or grease remover may be used to clean the outer surface 102 and remove any road tar or solvent soluble materials prior to sanding.

With reference to FIG. 5, because the temperature of the outer surface 102 is below the freezing point of water, the outer surface 102 of the workpiece 100 is sanded using a dry sanding process. The dry sanding process is performed without discharging any liquid onto the outer surface 102 of the workpiece 100. As such, during dry sanding, sanding occurs solely when the outer surface 102 of the workpiece 100 is completely dry to allow proper sanding of the outer surface 102. The cryogenic process may further include continuously emitting the cryogen CR toward the outer surface 102 of the workpiece 100 at the same time as the dry sanding process is performed. The operator may stop emitting the cryogen CR toward the outer surface 102 of the workpiece 100 solely when the dry sanding process is completed. Dry sanding entails moving a dry sander 206 along the outer surface 102 of the workpiece 100 while the dry sander 206 is in direct contact with the outer surface 102. The dry sander 206 is substantially similar to the wet sander 106, except that it does not include features (e.g., tubing 116) for discharging water onto the outer surface 102.

The nozzle 124 may be moved at the same time as the dry sander 206 is moved along the outer surface 102 such that the dry sander 206 follows the nozzle 124 to allow the dry sander 206 to work on a portion of the outer surface 102 that has already been cooled by the cryogenic CR emitted from the nozzle 124. The dry sander 206 and the nozzle 124 are moved simultaneously. For example, the dry sander 206 is moved in a direction O orthogonal to the outer surface 102 and the nozzle 124 is moved moving the same direction (i.e., the direction O orthogonal to the outer surface 102). The dry sander 206 and the nozzle 124 are moved at the same speed to maintain a space between the dry sander 206 and the nozzle 124 while moving the dry sander 206 and the nozzle 124. The space has a constant distance SD measured from the dry sander 206 to the nozzle 124 along the direction O orthogonal to the outer surface 102 to avoid emitting cryogen CR toward the dry sander 206.

While the best modes for carrying out the disclosure have been described in detail, those familiar with the art to which this disclosure relates will recognize various alternative designs and embodiments for practicing the disclosure within the scope of the appended claims.

What is claimed is:

1. A method, comprising:
Actively cooling an outer surface of a workpiece until the outer surface reaches a predetermined surface temperature, wherein the workpiece includes a thermoplastic polyolefin; and
sanding the outer surface of the workpiece when the outer surface of the workpiece has reached the predetermined surface temperature.

2. The method of claim 1, wherein the predetermined surface temperature is less than 68 degrees Fahrenheit.

3. The method of claim 1, wherein the predetermined surface temperature is between 33 degrees Fahrenheit and 67 degrees Fahrenheit.

4. The method of claim 1, further comprising maintaining the outer surface at the predetermined surface temperature while sanding the outer surface.

5. The method of claim 1, wherein actively cooling includes dipping the workpiece in water, the water is contained in a reservoir, and a temperature of the water is between 33 degrees Fahrenheit and 67 degrees Fahrenheit.

6. The method of claim 5, wherein the dipping the workpiece in water includes dipping the workpiece in water at least five minutes.

7. The method of claim 6, further comprising removing the workpiece from the reservoir, wherein sanding the outer surface of the workpiece is performed after removing the workpiece from the reservoir.

8. The method of claim 7, wherein sanding the outer surface of the workpiece includes a wet sanding process, and the wet sanding process includes discharging water onto the outer surface of the workpiece onto the outer surface after the outer surface has reached the predetermined surface temperature.

9. The method of claim 8, wherein the discharged water has a water temperature is between 33 degrees Fahrenheit and 52 degrees Fahrenheit.

10. The method of claim 1, wherein actively cooling the outer surface of the workpiece includes a cryogenic process, the cryogenic process includes emitting a cryogen toward the outer surface of the workpiece to cool the outer surface of the workpiece, and a temperature of the cryogen is equal to or less than −109 degrees Fahrenheit.

11. The method of claim 10, wherein the cryogenic process includes emitting the cryogen toward the outer surface of the workpiece for 3 seconds, and the cryogenic includes carbon dioxide.

12. The method of claim 10, wherein the cryogenic process includes emitting the cryogenic toward the outer surface of the workpiece for one second, and the cryogen includes nitrogen.

13. The method of claim 10, wherein sanding the outer surface of the workpiece includes a dry sanding process, and the dry sanding process is performed without discharging a liquid onto the outer surface of the workpiece.

14. The method of claim 13, wherein the cryogenic process further includes continuously emitting the cryogenic toward the outer surface of the workpiece at the same time as the dry sanding process is performed.

15. The method of claim 14, wherein the cryogenic process includes emitting the cryogenic through a nozzle, the dry sanding process includes moving a dry sander along the outer surface while the dry sander is in direct contact with the outer surface, and the method further includes moving the nozzle at the same time as the dry sander is moved along the outer surface such that the dry sander follows the nozzle to allow the dry sander to work on a portion of the outer surface that have been already cooled by the cryogen emitted from the nozzle.

16. A method, comprising:
actively cooling an outer surface of a workpiece until the outer surface reaches a predetermined surface temperature, wherein the predetermined surface temperature is less than 68 degrees Fahrenheit, the workpiece includes a thermoplastic polyolefin, the thermoplastic polyolefin includes a polypropylene matrix and rubber particles, and the rubber particles are dispersed throughout the polypropylene matrix; and
sanding the outer surface of the workpiece when the outer surface of the workpiece has reached the predetermined surface temperature.

17. The method of claim 16, wherein the predetermined surface temperature is between 33 degrees Fahrenheit and 67 degrees Fahrenheit.

18. The method of claim 16, wherein:
actively cooling the outer surface of the workpiece includes dipping the workpiece in reservoir water;
the reservoir water is contained in a reservoir;
a temperature of the reservoir water is between 33 degrees Fahrenheit and 67 degrees Fahrenheit;
the dipping the workpiece in water includes dipping the workpiece in water solely for five minutes;
the method further includes completely removing the workpiece from the reservoir, sanding the outer surface of the workpiece is performed after completely removing the workpiece from the reservoir;
sanding the outer surface of the workpiece includes a wet sanding process;
the wet sanding process includes discharging water onto the outer surface of the workpiece to maintain the outer surface at the predetermined surface temperature;
a temperature of the discharged water is between 33 degrees Fahrenheit and 67 degrees Fahrenheit;
the wet sanding process is performed using a wet sander;
the wet sander includes a support body, a rotatable sanding pad coupled to the support body, a first guide post protruding from the support body, a second guide post protruding from the support body, and a tubing coupled to the support body and configured to deliver the water to be discharged onto the outer surface of the workpiece;
the tubing has a thermal insulation, and the thermal insulation has an R-value of 7 ft²·° F.·h/Btu to minimize heat transfer between the water flowing through the tubing and an atmosphere;
the first guide post is wholly made of polytetrafluoroethylene;
the second guide post is made of polytetrafluoroethylene, the first guide post is in direct contact with the outer surface of the workpiece during the wet sanding process;
the second guide post is in direct contact with the outer surface of the workpiece during the wet sanding process; and
the workpiece is a front bumper of a vehicle, and dipping the workpiece into water includes dipping the workpiece such that an entirety of the outer surface is submerged in the reservoir water.

19. The method of claim 16, wherein:
actively cooling the outer surface of the workpiece includes a cryogenic process;
the cryogenic process includes emitting a cryogen toward the outer surface of the workpiece to cool the outer surface of the workpiece;
a temperature of the cryogen is −109 degrees Fahrenheit before being emitted toward the outer surface of the workpiece;
the cryogen solely includes carbon dioxide;
sanding the outer surface of the workpiece solely includes a dry sanding process;
the dry sanding process is performed without discharging a liquid onto the outer surface of the workpiece so that the sanding occurs solely when the outer surface of the workpiece is completely dry;
the cryogenic process further includes continuously emitting the cryogen toward the outer surface of the workpiece at the same time as the dry sanding process is performed;
stopping emitting the cryogen toward the outer surface of the workpiece solely when the dry sanding process is completed;
the cryogenic process includes emitting the cryogenic through a nozzle;
the dry sanding process includes moving a dry sander along the outer surface while the dry sander is in direct contact with the outer surface;
the method further includes moving the nozzle at the same time as the dry sander is moved along the outer surface such that the dry sander follows the nozzle to allow the dry sander to work on a portion of the outer surface that has already been cooled by the cryogen emitted from the nozzle;
moving the dry sander and moving the nozzle occur simultaneously;
moving the dry sander includes moving the dry sander in a direction orthogonal to the outer surface;
moving the nozzle includes moving the nozzle at the direction orthogonal to the outer surface;
moving the dry sander includes moving the dry sander at a first speed;
moving the nozzle includes moving the nozzle at a second speed, the first speed is equal to the second speed;
the method further includes maintaining a space between the dry sander and the nozzle while moving the dry sander and the nozzle;
the space has a constant distance measured from the dry sander to the nozzle along the direction orthogonal to the outer surface;
the method further includes maintaining the constant distance of the space while moving the dry sander and the nozzle to avoid emitting cryogen toward the dry sander;
the carbon dioxide is in liquid state before the being emitted from the nozzle;
the carbon dioxide vaporizes when being emitted from the nozzle;
the nozzle has a first nozzle end and a second nozzle end opposite the first nozzle end;
the carbon dioxide is emitted from the second nozzle end;
the second nozzle end is spaced apart from the outer surface of the workpiece to allow the carbon dioxide to vaporize before contacting the outer surface of the workpiece;
the thermoplastic polyolefin further includes additives;
the additives include talc and pigments;
the method further includes painting the outer surface of the workpiece after sanding the outer surface of the workpiece; and
the workpiece is a front bumper of a vehicle.
